(19) United States
(12) Patent Application Publication
(10) Pub. No.: US 2020/0134360 A1
(43) Pub. Date: Apr. 30, 2020

(54) Methods for Decreasing Computation Time Via Dimensionality

(71) Applicant: Emerald Logic, Inc., Aliso Viejo, CA (US)

(72) Inventors: Patrick Lilley, Aliso Viejo, CA (US); Michael John Colbus, Upland, CA (US)

(21) Appl. No.: 15/643,441

(22) Filed: Jul. 6, 2017

(51) Int. Cl. G06K 9/62; G06F 17/16; G06F 17/30

(52) U.S. Cl. CPC G06K 9/6221; G06F 17/16; G06N 99/005; G06F 17/30631; G06F 17/30333

(57) ABSTRACT

Dimensionality reduction in high-dimensional datasets can decrease computation time, and processes for dimensionality reduction may even be useful in lower-dimensional datasets. It has been discovered that methods of dimensionality reduction may dramatically decrease computational requirements in machine learning programming techniques. This development unlocks the ability of computational modeling to be used to solve complex problems that, in the past, would have required computation time on orders of magnitude too great to be useful.

### FIELD OF THE INVENTION

The field of the invention is methods for decreasing computation time via dimensionality reduction.

### BACKGROUND

The background description includes information that may be useful in understanding the present invention. It is not an admission that any of the information provided in this application is prior art or relevant to the presently claimed invention, or that any publication specifically or implicitly referenced is prior art.

As availability and size of datasets increases “curse of dimensionality” prohibits large scale data operations.

When analyzing high-dimensional spaces, with many hundreds or even thousands of dimensions, computing problems arise that do not occur in low-dimensional settings, such as three- or two-dimensional settings. The problem with these spaces is that the time to compute numerical solutions to certain problems can be orders of magnitude too high to be useful. One example of problems in high-dimensional data solutions is devising a perfect strategy for the board game “Go.” A solution for Go is easy to conceive, yet impossible to compute: for each move, the best possible move for a player is one that results in a set of possible future moves that is most likely to result in that player's victory. But the set of possible future moves is too high to compute that probability: it would take longer than the age of the universe to compute the entire space. Thus, artificial intelligence solutions designed to play “Go” must reduce the dimensionality of the problem to arrive at solutions. Another example is screening genetics for disease risk. The number of possible genes that may affect the risk of developing an adverse trait, and the various combinations of genes that may affect the risk, is too high to compute efficiently for each possible gene and gene combination. In other problems with a large number of possible variables that influence an outcome, similar problems of high-dimensionality exist in constructing models. The number of possible models that include one or more variables from a set of hundreds or thousands of variables is prohibitively large to efficiently search. Thus, reducing the number of variables reduces the space of possible models to search for a particular problem.

Problems of high-dimensionality arise in numerical analysis, sampling, combinatorics, machine learning, data mining, and databases. Organizing and searching data often relies on detecting groups of objects with similar properties, but in high-dimensional data, all objects may appear dissimilar in many ways, which can prevent efficient data organization and search.

One way to reduce problems that arise in high-dimensional datasets is to reduce the number of relevant dimensions before engaging in the most computationally intensive processes. This, however, raises several different problems. First, the method of decreasing dimensionality must itself be significantly computationally “cheaper,” i.e. take less processing time given a constant processing power, than any computationally intensive process that follows. Second, the method of decreasing dimensionality must also provide sufficient accuracy that features of sufficient potential relevance are not altogether lost in the dimensionality reduction.

Although computer technology continues to advance, there still exists a need to reduce computational requirements for high-dimension computational programming in a way that makes complex computational techniques available for solving complex problems using large datasets.

In machine learning, “feature selection” refers to the process of reducing the number of dimensions of a dataset by finding a subset of original variables or features that offer the highest predictive value for a problem. Traditional feature selection processes include wrapper methods, in which a predictive model is used to score feature subsets; filter methods, in which a fast-to-compute “proxy measure” is used to score feature subsets; and embedded methods, which refers to a set of techniques used as part of a model construction process. In these background methods of feature selection, each is relatively computationally expensive and does not perform well across many types of models.

It has yet to be appreciated that dimensionality reduction can be performed in a manner that both reduces computation time and performs well across many types of models applied to the reduced-dimensionality dataset. It also has yet to be appreciated that dimensionality reduction processes may be useful even in low-dimensional spaces.

Thus, there is still a need in the art for methods for decreasing computation time via dimensionality reduction.

### SUMMARY OF THE INVENTION

The present invention provides apparatus, systems, and methods in which computation time required to model high-dimensional datasets may be reduced by a method of reducing dimensionality.

In one aspect of the inventive subject matter, a method for decreasing computation time via dimensionality reduction is contemplated. The method includes several steps, the steps comprising storing a first set of data comprising a set of entries, wherein each entry of the set of entries comprises (1) at least one criterion and (2) an outcome; creating first and second entry subsets from the first set of data; determining first and second explanatory measures corresponding to the first and second entry subsets, wherein the first explanatory measure is based on: at least one first entry subset criterion which corresponds to a first outcome type of the first entry subset; wherein the second explanatory measure is based on: at least one second entry subset criterion which corresponds to a second outcome type of the second entry subset; determining a consistency measure for the at least one criterion, wherein the consistency measure is based on a measure of variability of at least the first and second explanatory measures; comparing the consistency measure for the at least one criterion to a threshold; and rejecting the at least one criterion from the first set of data if the consistency measure for the at least one criterion is below a threshold.

In another aspect of the invention, a method of decreasing computation time required to improve models which relate predictors and outcomes by preprocessing a dataset comprises storing a first set of data comprising a set of entries, wherein each entry of the set of entries comprises (1) at least one feature and (2) an outcome; defining first and second entry subsets from the first set of data; defining a first entry outcome subset from the first entry subset, wherein each outcome of the first entry outcome subset is substantially the same; defining a second entry outcome subset from the first entry subset, wherein each outcome of the second entry outcome subset is substantially the same; defining a third entry outcome subset from the second entry subset, wherein each outcome of the third entry outcome subset is substantially the same; defining a fourth entry outcome subset from the second entry subset, wherein each outcome of the fourth entry outcome subset is substantially the same; determining a first outcome measure corresponding to the first entry outcome subset, wherein the first outcome measure is based on: at least one first entry outcome subset feature which is representative of a first entry outcome subset feature type; determining a second outcome measure corresponding to the second entry outcome subset, wherein the second outcome measure is based on: at least one second entry outcome subset feature; determining a third outcome measure corresponding to the third entry outcome subset, wherein the third outcome measure is based on: at least one third entry outcome subset feature; determining a fourth outcome measure corresponding to the fourth entry outcome subset, wherein the fourth outcome measure is based on: at least one fourth entry outcome subset feature; determining a first final outcome measure which is based on the first outcome measure and the second outcome measure; determining a second final outcome measure which is based on the third outcome measure and the fourth outcome measure; determining a consistency measure associated with a feature type, wherein the consistency measure is based on a measure of variability of the first and second final outcome measures; and comparing the consistency measure associated with the feature type to a threshold, and, if the consistency measure is less than the threshold, rejecting the feature type from the first set of data.

In yet another aspect of the invention, an apparatus is provided for decreasing computation time required to improve models which relate predictors and outcomes by preprocessing a dataset, the apparatus comprising a result quantization module configured to receive (1) a dataset comprising at least four rows and at least two columns, wherein a first column corresponds to a feature type and a second column corresponds to a result, (2) a number of quanta, wherein the result quantization module quantizes column that corresponds to a result to reduce the dimensionality of the result according to the number of quanta; a subset creation module configured to receive (1) the dataset, (2) a number of subsets, (3) a selection method, whereby subsets are created according to (1) the number of subsets and (2) the selection method; a subsubset creation module configured to receive the subsets, whereby at least two subsubsets are created for each of the subsets received, wherein the second column of each subsubset has the same value; a representative metric module configured to receive (1) the at least two subsubsets and (2) a representative metric determination method, whereby the representative metric module determines a representative metric for each of the first column of the at least two subsubsets based on the representative metric determination method; a combination module, configured to combine the representative metric for each of the first column of the at least two subsubsets corresponding to a designated subset and to output a combination module result, wherein the output according to a first subset is a first combination module result, and the output according to a second subset is a second combination module result; a consistency metric module configured to determine a measure of variability of (1) the first combination module result corresponding to a first designated subset and (2) the second combination module result corresponding to a second designated subset; a feature power module comprising a mode selector configured to output a mode selector output based on the first combination module result and second combination module result, and a combiner unit, wherein the combiner unit is configured to output a feature power module result based on the mode selector output, the first combination module result, and the second combination module result a selection module configured to reduce the dimensionality of the dataset according to at least one of (1) the feature power module result, (2) the measure of variability, and (3) the first combination module result.

It should be appreciated that the disclosed subject matter provides advantageous technical effects including improved operation of a computer by dramatically decreasing computational cycles required to perform certain tasks (e.g., genetic programming). In the absence of the inventive subject matter, genetic programming is not a tenable solution in many situations due in large part to its steep computational requirements that would necessitate sometimes months and years of computing time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 shows an exemplary dataset.

FIG. 2 shows an exemplary process according to the invention.

FIG. 3 shows a result quantization module.

FIG. 4 shows a subset creation module.

FIG. 5 shows a subsubset creation module.

FIG. 6 shows a representative metric module.

FIG. 7 shows an exemplary subsubset and associate representative metrics.

FIG. 8 shows a combination module.

FIG. 9 shows an array of feature metrics.

FIG. 10 shows a consistency metric module.

FIG. 11 shows a feature power module.

FIG. 12 shows a selection module.

### DETAILED DESCRIPTION

Definitions

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

As used in this application, terms like “set” or “subset” are meant to be interpreted to include one or more items. It is not a requirement that a “set” include more than one item unless otherwise noted. In some contexts, a “set” may even be empty and include no items.

The purpose of the inventive subject matter is to identify and eliminate low performing (e.g., unnecessary or unneeded) model components that are used to create models that describe relationships between predictors and outcomes in target datasets. Pruning the number of possible model components improves computational efficiency by decreasing computation time required to converge on high performing models.

The present invention's many embodiments serve to illustrate the invention.

In one embodiment, the invention comprises a set of software instructions.

In another embodiment, the invention comprises specialized hardware that improves the functioning of a generic computer in the context of the invention described herein.

In yet another embodiment, the invention comprises specialized hardware that improves the functioning of a generic computer.

Dataset

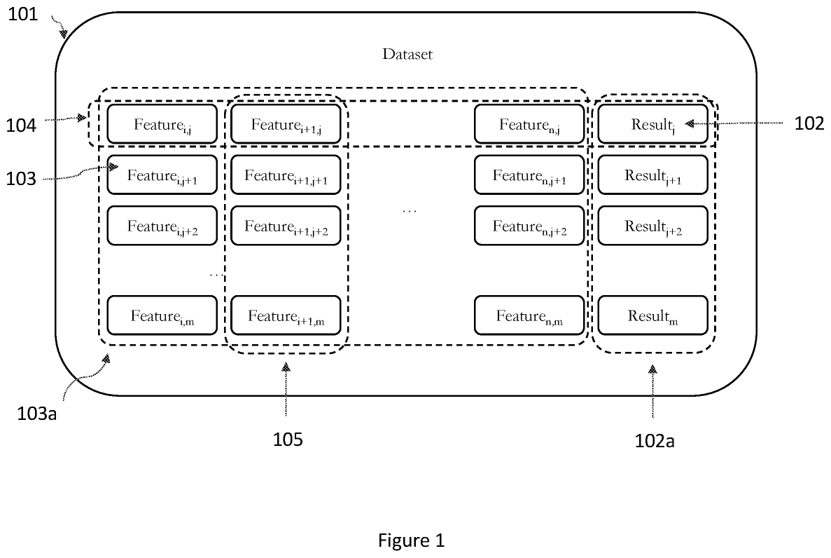

In one embodiment of the invention, modules are provided to operate on dataset 101. Exemplary aspects of dataset 101 are described in FIG. 1. By reference to FIG. 1, exemplary aspects include result 102 and feature 103 associated with result 102. Result 102 may be indexed by its location in computer-accessible memory, or by another indexing method, thereby forming Result array 102a. Similarly, feature 102 may be indexed by its location in memory, or by another indexing method, forming feature array 103a. As FIG. 1 depicts, dataset 101 may comprise an array of features and results, such that Result array 102a may be distinguishable from Feature array 103a by an indexing method to identify a particular column of dataset 101. (In FIG. 1, for example, the index “n+1” could be equivalent to the Result column.) Further, each row in the dataset may be indexed another way, such that an index address such as “i,j” is made equivalent to a single parameter index, k, by the following formula: k=j*[number of rows]+i. Sample 104 comprises at least one feature and at least one result. Within dataset 101, a feature indexed by a same column index will be of a common type as features of the same column index and a different row index, thereby forming feature type 105. Of course, different indexing schemes are possible to group features of a common type.

Process

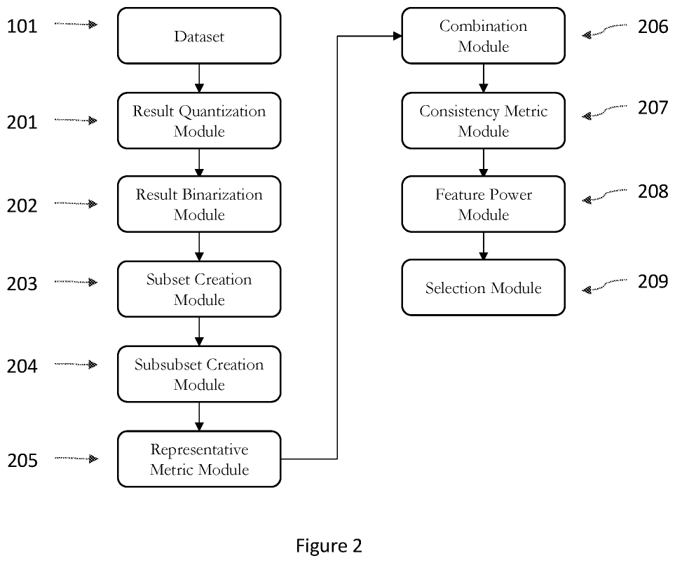

FIG. 2 depicts an exemplary process using the invention. Dataset 101 is input to result quantization module 201, which process the dataset. In some embodiments, result binarization module 202 may further process dataset 101 after processing by result quantization module 201. As shown in FIG. 2, subset creation module 203 is invoked after both result quantization module 201 and result binarization module 202. In some embodiments, subset creation module may be invoked either before or after result quantization module 201 or result binarization module 202. Subsubset creation module 204 is then invoked after subset creation module 203. Processing invokes representative metric module 205, combination module 206, consistency metric module 207, feature power module 208, and selection module 209, which are described in further detail below.

Result Quantization Module

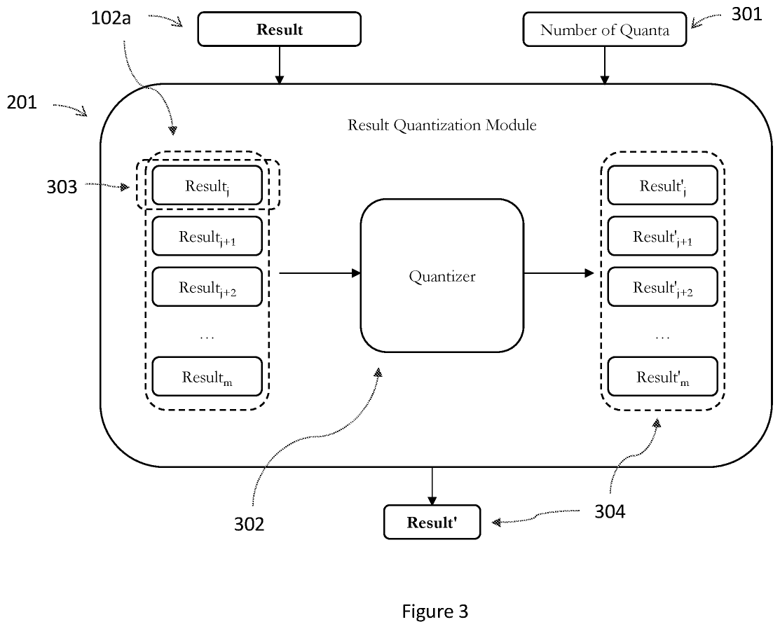

Also described is result quantization module 201 by way of reference to FIG. 3. Result quantization module 201 takes inputs comprising Result array 102a and number of quanta 301. Each result in the Result array 102a is input into quantizer 302, as shown in FIG. 3. When quantizer 302 receives result 303, it determines whether result 303 is between a first value and a second value that define the range of a quantum. If result 303 is between a first value and a second value that define the range of a quantum, the output of quantizer 302 corresponding to the input result will be said quantum, thereby defining a value for a result. For certain inputs, quantizer 302 may be further optimized. For example, if result in result array 102a comprises unsigned integers and number of quanta 301 is a power of two, quantizer 302 may operate by bit shifting result 303 to eliminate least significant bit(s), such that the resulting range of quantizer 302 output equals number of quanta 301. Thus, quantizer 302 outputs quantized result array 304.

The ranges of values that define the quanta may be either predefined or determined from the range of values in Result array 102a and the number of quanta. In one embodiment, for example, quantizer 302 will determine an appropriate mapping function to transform Result array 102a so that it may be reasonably approximated as an output of a uniformly distributed randomizing function. If Result array 102a is already closely approximated as such, the transformation would be identity. In one embodiment in which the transformed Result array 102a may be reasonably approximated as uniformly distributed, the range of values that define the quanta will be determined to be uniformly distributed between the full range of Result array 102a.

Result Binarization Module

Also described is result binarization module 202, which is present in some embodiments. Result binarization module 202 receives as input either Result array 102a or quantized result array 304. Result binarization module 202 also receives as an input a parameter to select one quantum among the quanta in result array 102a. The possible values for each result in result array 102a or quantized result array 304 are then reduced to two values by quantization to form a binarized result.

Subset Creation Module

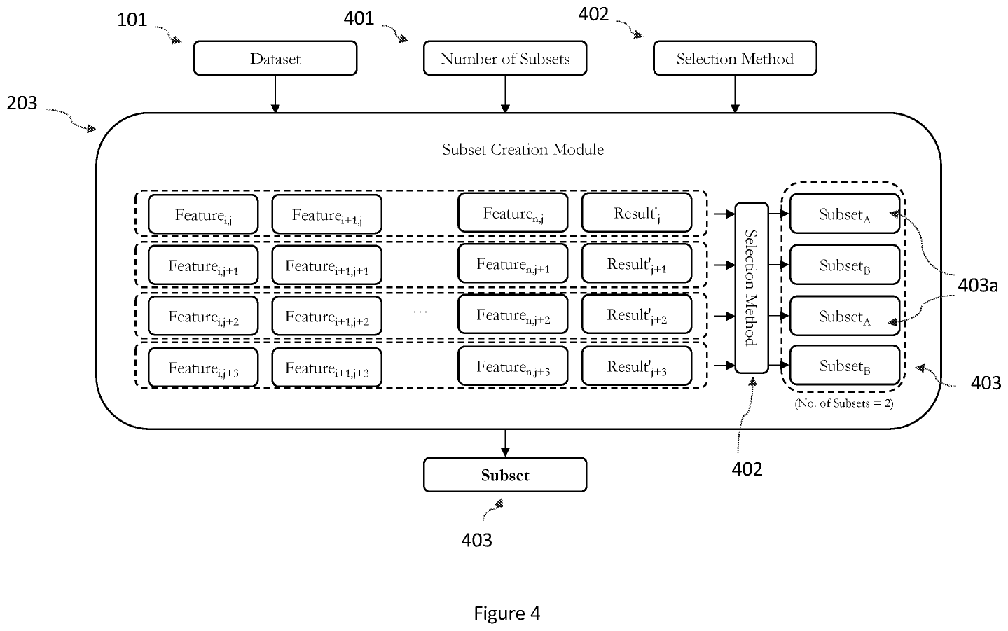

Also described is subset creation module 203 as shown in FIG. 4. Subset creation module 203 receives as input dataset 101, number of subsets 401, and selection method 402. Number of subsets 401 typically would be determined by one skilled in the art, but in some embodiments may be determined based on dataset 101. Subset creation module 203 associates each sample with one of subsets 403. The association may be accomplished, for example, by creating a list of memory locations, where each memory location points to a sample in dataset 101. Subset 403a, for example, then may be defined by the list. By creating a list of memory locations instead of copying all data in each sample to a new location in memory, the memory required to perform the process described herein is reduced significantly, such that the process described herein is possible to perform on significantly greater numbers of available devices.

Selection method 402 may be, for example, random without replacement, random with replacement, or a special-defined method. Subsets 403 are created, for example, by iterating over number of subsets 401 and a number of samples to populate each subset with. When the selection method is random without replacement, selection method 402 prohibits a sample from appearing in more than one subset of subsets 403. In one embodiment, selection method 402 ensures that the distribution or proportion of results in subset 403a approximates the distribution or proportion of results in the dataset. Thus, a proportion of results in a first subset, e.g. subset 403a, and a proportion of results in a second subset are the same in such embodiment.

In one embodiment, selection method 402 may be described by way of example of an iteration. For example, in a first iteration, one sample, randomly selected, is associated with subset 403a. In another embodiment, for example, in the first iteration, subset 403a may be randomly selected from subsets 403 and associated with the first sample. If selection method 402 is random without replacement, one sample may appear in more than one subset.

As described above, selection method 402 may be a special-defined method in some embodiments. A special-defined method provides to subset creation module 203 a function for associating a subset with a sample, and it may be invoked by subset creation module 203.

Subsubset Creation Module

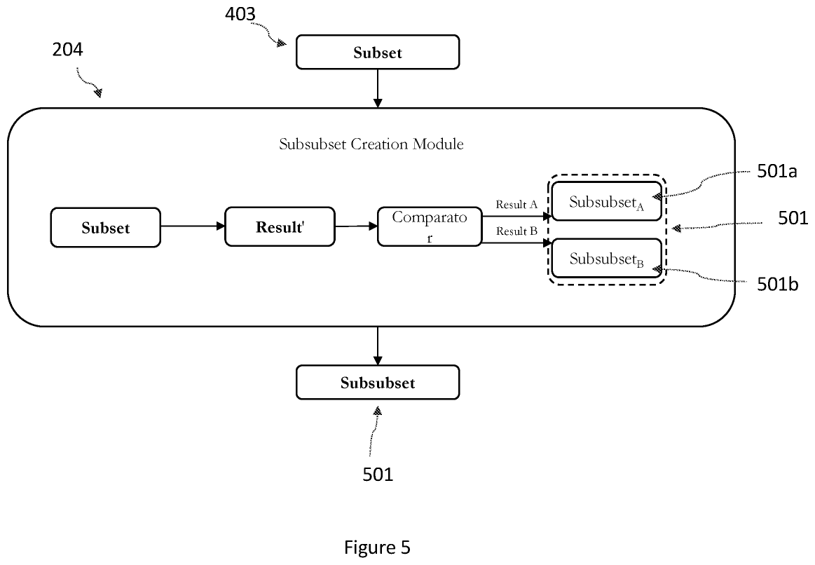

Another aspect of the invention is subsubset creation module 204, as shown in FIG. 5. In one embodiment, subsubset creation module 204 receives as input subsets 403. Subsubset creation module 204 creates, from a subset, subsubsets 501. Subsubset 501a is created, by way of example, by comparing the binarized result of sample 104 in subset 403a to a first value. If the comparison result is equal, sample 104 in subset 403a is added to subsubset 501a corresponding to subset 403a. If the comparison result is not equal, sample 104 in subset 403a is added to subsubset 501b corresponding to subset 403a. A subset input to subsubset creation module 204 will yield two subsubsets, which are separate from subsubsets that correspond to other subsets. Subsubset creation module 204 operates on at least one subset.

The subsubset creation module may be implemented as its own function, or, in some embodiments, as an indexing method through which samples are accessed in subsets. It will be appreciated by one skilled in the art that many implementations are possible without undue experimentation and without changing the character of the invention.

Representative Metric Module

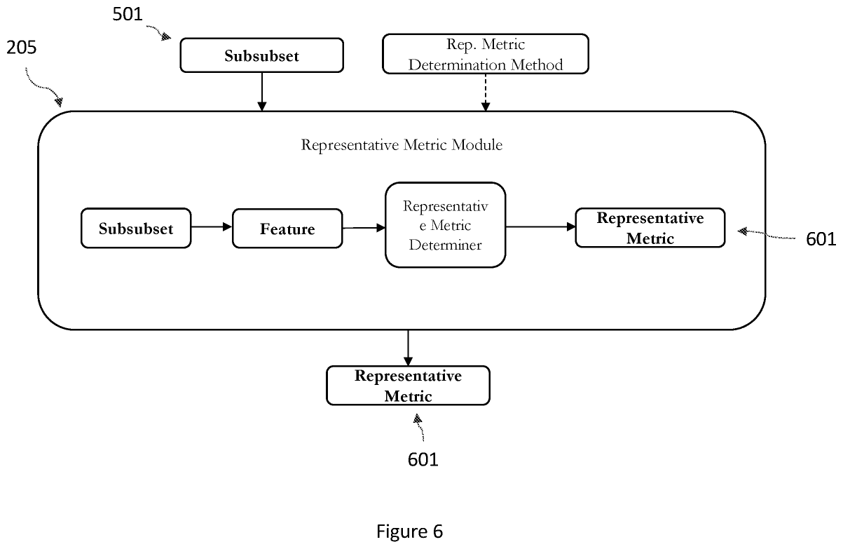

Subsubsets 501 output by subsubset creation module 204 are input to representative metric module 205 as shown in FIG. 6. Representative metric module 205 determines representative metric array 601, comprising at least one representative metric 601a for at least one feature type in a subsubset. For example, representative metric 601a may be determined as a trimean of each feature corresponding to feature type 105 within subsubset 501a by using the representative metric determiner, which determines a trimean or other estimator of a population mean. As another example, representative metric array 601 may comprise representative metric determined as median, arithmetic mean, or geometric mean of the features of a given feature type within a subsubset. More generally, representative metric array 601 may comprise representative metric that is an estimator of a population mean given samples for a feature type in a given subsubset. Optionally in some embodiments, representative metric module 205 may receive an input of representative metric determination method, which may provide to representative metric module an arbitrary method of determining an estimator of a population mean.

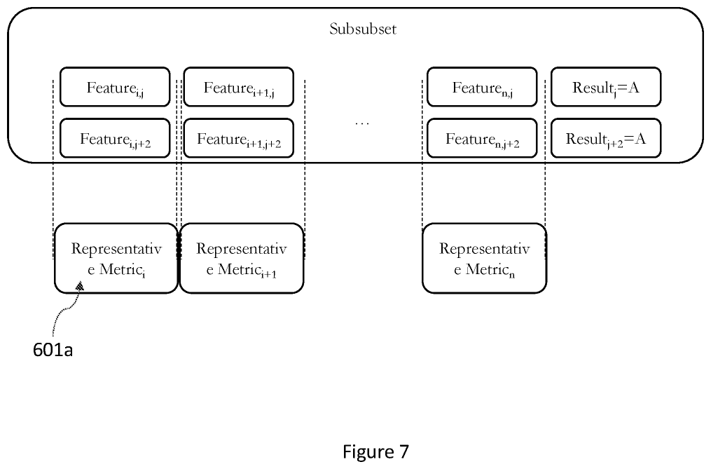

Thus, representative metric module 205 determines representative metric array 601, which may comprise a representative metric for each feature type of a subsubset for each subsubset input to the representative metric module. The association between representative metrics and features of a given feature type is depicted in FIG. 7.

Combination Module

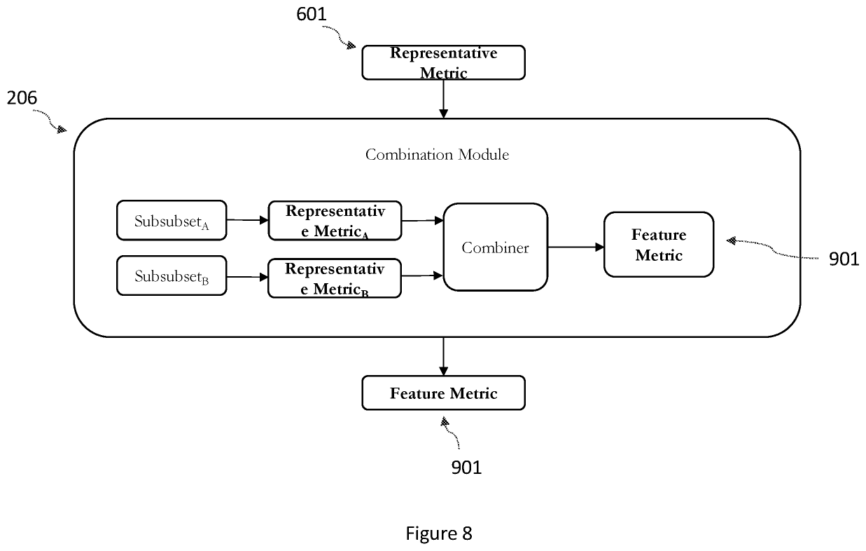

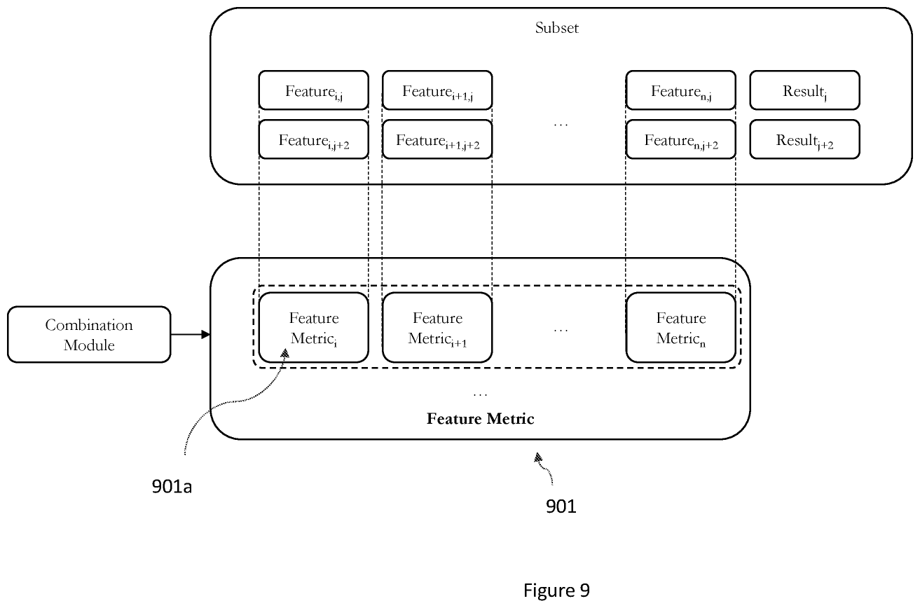

Representative metric array 601 is input to combination module 206 as shown in FIG. 8. Combination module 206 combines two representative metrics for a given subset—a first representative metric for the first subsubset of the given subset, and a second representative metric for the second subsubset of the given subset—by, for example, taking their ratio, to create a single feature metric per feature type per subset. Combination module output, feature metric array 901, is depicted in FIG. 9. As shown in FIG. 9, each feature metric, e.g. feature metric 901a, is associated with features of a given feature type of a given subset, thereby forming feature metric array 901. Thus, a first feature metric (corresponding to a first subset) is based on at least one first subset feature, and a second feature metric (corresponding to a second subset) is based on at least one second subset feature.

Consistency Metric Module

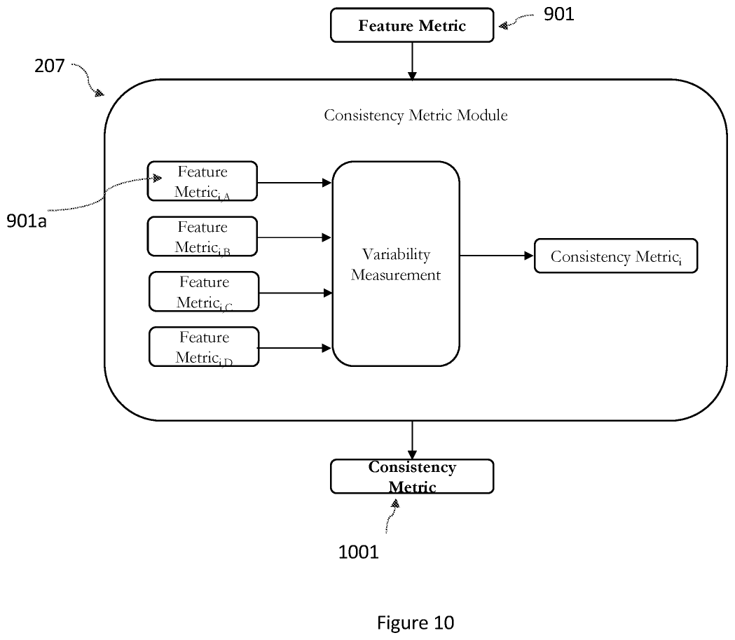

Feature Metric array 901 is input to consistency metric module 207, as shown in FIG. 10. Consistency metric module 207 determines a measure of variability of feature metrics corresponding to a given feature type across multiple subsets. The measure of variability may be calculated as, for example, a standard deviation, an estimate of standard deviation, or an estimate of standard deviation adjusted by the mean. In one embodiment, for example, the measure of variability may be determined by the standard deviation divided by the mean, thus being an estimate of standard deviation adjusted by the mean. The array of measures of variability for more than one feature type and more than one subset thereby forms the consistency metric array 1001. Thus output by the consistency metric module is consistency metric array 1001, wherein each of the at least one consistency metrics in the consistency metric array is associated with a feature type. Therefore, a first consistency metric for a feature type is based on at least a first feature metric (corresponding to a first subset) and a second feature metric (corresponding to a second subset).

Feature Power Module

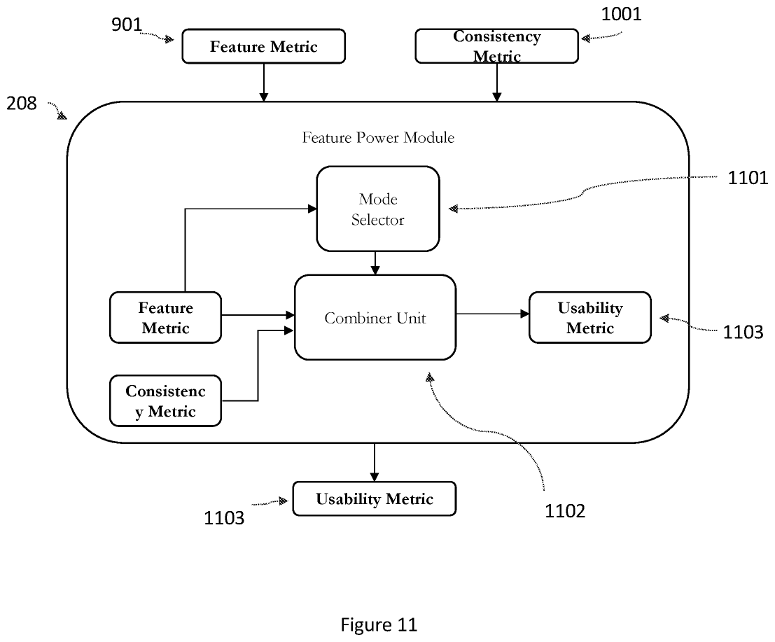

Also present in some embodiments is feature power module 208, as depicted in FIG. 11. Feature power module 208 receives feature metric array 901 (comprising at least one feature metric) and consistency metric array 1001. The feature power module includes mode selector 1101 and combiner unit 1102, wherein mode selector 1101 determines the type of combination to perform in combiner unit 1102 based on feature metric array 901. In one embodiment, the mode selector selects a first combination type upon determining that each sign of each feature metric for a given feature type is positive, a second combination type upon determining that each sign of each feature metric for a given feature type is negative, and a third combination type for all other cases.

Combiner unit 1102 operates in a different mode depending on the determination of mode selector 1101. If mode selector 1101 determines a first combination type for a given feature type, combiner unit 1102 operates in a first combination regime. In an exemplary embodiment, the first combination regime outputs a multiplication of (1) a measure of an average of each feature metric for a given feature type and (2) the consistency metric associated with the given feature type. If mode selector 1101 determines a second combination type for a given feature type, combiner unit 1102 operates in a second combination regime. In an exemplary embodiment, the second combination regime outputs a division of (1) and (2). Thus, the first combination regime and second combination regime are not identical. If mode selector 1101 determines a third combination type for a given feature type, combiner unit 1102 operates in a third combination regime. In an exemplary embodiment, the third combination regime outputs a predefined value, e.g. the product of zero and (1) and (2). Combiner unit 1102 thus outputs usability metric 1103, which is associated with a given feature type of dataset 101. The output of feature power module 208 is thus usability metric array 1104 (at least one usability metric) wherein a usability metric within the usability metric array corresponds to a feature type of the dataset.

Selection Module

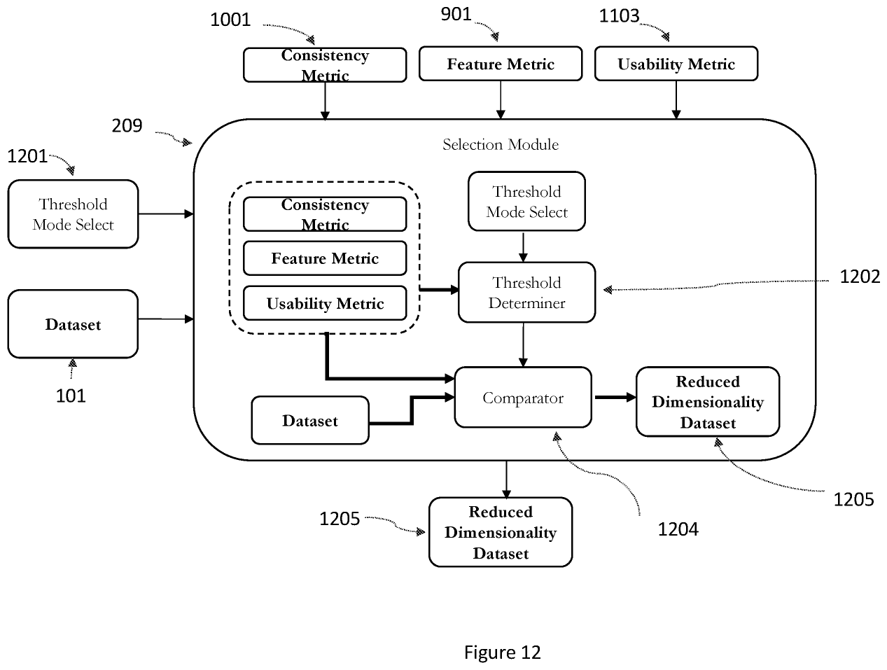

Also described is selection module 209, as depicted in FIG. 12. Selection module 209 inputs comprise consistency metric array 1001, feature metric array 901, usability metric array 1104, as well as threshold mode select 1201 and dataset 101. Selection module 209 reduces the dimensionality of the dataset based on the inputs. As shown in FIG. 12, consistency metric array 1001, feature metric array 901, and usability metric array 1104 are each input to threshold determiner 1202, which operates on a consistency metric, a feature metric, and a usability metric for a given feature type. Threshold determiner 1202 determines threshold value 1203 for discarding feature types from a feature set, wherein threshold value 1203 is based on at least one of a consistency metric, feature metric, and usability metric. In some embodiments, threshold mode select 1201 determines a mode for threshold determiner 1202. In a first mode determined by threshold mode select 1201, for example, threshold determiner 1202 determines cutoff threshold value 1203 to apply to usability metric array 1104. In the first mode, then, threshold determiner 1202 determines cutoff threshold value 1203 to be, for example, a median of the usability metric for all feature types. Thus, in the first mode under the median example for the threshold cutoff value 1203, half of all features would be associated with a usability metric that falls below cutoff threshold value 1203. In a second mode determined by threshold mode select 1201, for example, threshold determiner 1202 combines, either by addition, multiplication, or other method, at least two of consistency metric, usability metric, and feature metric into a threshold metric, and then determines cutoff threshold value 1203 based on a population of threshold metrics for a given feature type. In a third mode, for example, threshold determiner 1202 determines a threshold metric based on at least one of the consistency metric, usability metric, and feature metric and determines the threshold value of the threshold metric to be a predefined value.

Comparator 1204 determines a threshold metric according to the same process used by the threshold determiner. In some embodiments, then, the threshold determiner passes the computed threshold metrics to comparator 1204. Comparator 1204 then compares the threshold metric—which is based on at least one of the consistency metric, usability metric, and feature metric—for a given feature to cutoff threshold value 1203 determined by threshold determiner 1202. Threshold metric may be based on the at least one of the consistency metric, usability metric, and feature metric through transform, or may be equal to one of the consistency metric, usability metric, and feature metric. When comparator 1204 determines the threshold metric for a given feature type is below cutoff threshold value 1203, comparator 1204 removes the features of the given feature type from the dataset, thereby outputting reduced dimensionality dataset 1205.

It will be appreciated by one skilled in the art that the invention is not limited to the particular embodiments described herein, and additional embodiments are possible.

1. A method of decreasing computation time required to improve models which relate predictors and outcomes by preprocessing a dataset using an at least one computing device, the method comprising the steps of:
the at least one computing device storing a first set of data comprising a set of entries, wherein each entry of the set of entries comprises at least one feature and an outcome;
the at least one computing device creating first and second entry subsets from the first set of data;
the at least one computing device determining first and second explanatory measures corresponding to the first and second entry subsets, wherein the first explanatory measure is based on at least one first entry subset feature which corresponds to a first outcome type of the first entry subset, and wherein the second explanatory measure is based on at least one second entry subset feature which corresponds to a second outcome type of the second entry subset;
the at least one computing device determining a consistency measure for the at least one feature, wherein the consistency measure is based on a measure of variability of at least the first and second explanatory measures;
the at least one computing device comparing the consistency measure for the at least one feature to a threshold; and
the at least one computing device rejecting the at least one feature from the first set of data if the consistency measure for the at least one feature is below a threshold.

2. The method of claim 1, further comprising the step of the at least one computing device defining a value for each outcome in the first set of data.

3. The method of claim 1, wherein the first outcome type and second outcome type are the same.

4. The method of claim 1, wherein the first entry subset comprises a number of entries from the first set of data and a first proportion of outcomes within the first entry subset is substantially the same as a second proportion of outcomes within the first set of data.

5. The method of claim 1, wherein step of creating the first entry subset from the first set of data further comprises the step of the at least one computing device randomly selecting entries from the first set of data.

6. The method of claim 1, wherein step of determining the first and second explanatory measures further comprises the step of the at least one computing device determining an average involving the at least one feature, wherein the at least one feature corresponds to the first outcome type.

7. The method of claim 6, wherein the average is determined as a trimean.

8. The method of claim 6, wherein the average is determined as a geometric average.

9. The method of claim 6, wherein the average is determined as an arithmetic mean.

10. A method of decreasing computation time required to improve models which relate predictors and outcomes by preprocessing a dataset using an at least one computing device, the method comprising the steps of:
the at least one computing device storing a first set of data comprising a set of entries, wherein each entry of the set of entries comprises at least one feature and an outcome;
the at least one computing device defining first and second entry subsets from the first set of data;
the at least one computing device defining a first entry outcome subset from the first entry subset, wherein each outcome of the first entry outcome subset is substantially the same;
the at least one computing device defining a second entry outcome subset from the first entry subset, wherein each outcome of the second entry outcome subset is substantially the same;
the at least one computing device defining a third entry outcome subset from the second entry subset, wherein each outcome of the third entry outcome subset is substantially the same;
the at least one computing device defining a fourth entry outcome subset from the second entry subset, wherein each outcome of the fourth entry outcome subset is substantially the same;
the at least one computing device determining a first outcome measure corresponding to the first entry outcome subset, wherein the first outcome measure is based on at least one first entry outcome subset feature which is representative of a first entry outcome subset feature type;
the at least one computing device determining a second outcome measure corresponding to the second entry outcome subset, wherein the second outcome measure is based on at least one second entry outcome subset feature;
the at least one computing device determining a third outcome measure corresponding to the third entry outcome subset, wherein the third outcome measure is based on at least one third entry outcome subset feature;
the at least one computing device determining a fourth outcome measure corresponding to the fourth entry outcome subset, wherein the fourth outcome measure is based on at least one fourth entry outcome subset feature;
the at least one computing device determining a first final outcome measure which is based on the first outcome measure and the second outcome measure;
the at least one computing device determining a second final outcome measure which is based on the third outcome measure and the fourth outcome measure;
the at least one computing device determining a consistency measure associated with a feature type, wherein the consistency measure is based on a measure of variability of the first and second final outcome measures; and
the at least one computing device comparing the consistency measure associated with the feature type to a threshold, and, if the consistency measure is less than the threshold, rejecting the feature type from the first set of data.

11. The method of claim 10, wherein the first, second, third, and fourth entry outcome subsets are different.

12. The method of claim 10, wherein the at least one first entry outcome subset feature comprises an average of each feature in the first entry outcome subset.

13. The method of claim 10, further comprising the step of the at least one computing device determining a first average using at least the first final outcome measure and the second final outcome measure.

14. The method of claim 13, further comprising the step of the at least one computing device determining a final metric based on at least the first average and the consistency measure associated with the feature type.

15. The method of claim 10, wherein at least one outcome of at least one entry is determined from quantization of a second set of data.

16. (canceled)
